(19) United States
(12) Patent Application Publication
(10) Pub. No.: US 2018/0287322 A1
(43) Pub. Date: Oct. 4, 2018

(54) ELECTRICAL RECEPTACLE WITH IN-LINE POWER UNIT

(71) Applicant: Group Dekko, Inc., Garrett, IN (US)

(72) Inventors: Daniel Hayes, Kendallville, IN (US); Brian Rupert, Kendallville, IN (US)

(73) Assignee: Group Dekko, Inc., Garrett, IN (US)

(21) Appl. No.: 15/471,044

(22) Filed: Mar. 28, 2017

(51) Int. Cl. H01R 33/88; H01R 24/28

(52) U.S. Cl. CPC H01R 33/88; H01R 2103/00; H01R 24/28

(57) ABSTRACT

An elevatable work apparatus with an electrical receptacle assembly. The apparatus including a work surface and an elevation changing mechanism coupled to the work surface. The electrical receptacle assembly is coupled to the work surface and includes first and second electrical power cables; and first and second housings. The first housing has at least one electrical power receptacle, with the first electrical power cable providing electrical power to the first housing. The second electrical power cable is directly electrically coupled to the first electrical power cable. The second housing has at least one electrical receptacle connector presented on a face thereof. The second electrical power cable is coupled to the second housing and supplies electrical power to the electrical receptacle of the second housing.

### BACKGROUND OF THE INVENTION

### 1. Field of the Invention

The present invention relates to electrical power receptacles units, and, more particularly to, electrically in-line power units for coupling with work surfaces.

### 2. Description of the Related Art

In many applications, electrical receptacles are needed to receive and distribute power. They are required in permanent locations such as walls in fixed structures, as well as temporary locations such as modular office furniture. Many types of receptacles are required according to the needs of users. Some receptacles, for example, include distribution of power for computers, telephones, corded appliances, and charging stations etc. The electrical receptacles also are required in places that are convenient for the user, and may need to be re-located. A typical workstation will have a computer which is connected to a local area network (LAN), to a dedicated or shared printer and/or remote storage devices. Most such devices require access to a power supply, and many require communications cables to interface with other local and remote devices. In a workstation the power supply and interface cabling can be installed and bundled, but this tends to be unsightly and can interfere with the efficient use of space in a small workstation.

Workstations that are vertically extendable additionally have issues with power cords that may disengage or be pulled off of the surface when the elevation of the work surface is changed.

What is needed in the art is a receptacle system assembly that will allow a work surface accessible receptacle housing to receive electrical power delivery that is not impacted by movement of the work surface.

### SUMMARY OF THE INVENTION

The present invention is directed to an improved electrical receptacle arrangement having housings on top and bottom sides of a work surface.

The present invention provides an electrical receptacle assembly that is couplable to a work surface and includes first and second electrical power cables; and first and second housings. The first housing has at least one electrical power receptacle, with the first electrical power cable providing electrical power to the first housing. The second electrical power cable is directly electrically coupled to the first electrical power cable. The second housing has at least one electrical receptacle connector presented on a face thereof. The second electrical power cable is coupled to the second housing and supplies electrical power to the electrical receptacle of the second housing.

The present invention further provides an elevatable work apparatus with an electrical receptacle assembly. The apparatus including a work surface and an elevation changing mechanism coupled to the work surface. The electrical receptacle assembly is coupled to the work surface and includes first and second electrical power cables; and first and second housings. The first housing has at least one electrical power receptacle, with the first electrical power cable providing electrical power to the first housing. The second electrical power cable is directly electrically coupled to the first electrical power cable. The second housing has at least one electrical receptacle connector presented on a face thereof. The second electrical power cable is coupled to the second housing and supplies electrical power to the electrical receptacle of the second housing.

An advantage of the present invention is that the work surface power delivery device is coupled to another housing secured to the bottom side of the work surface.

Another advantage of the present invention is that the power cord leaving the surface power delivery system is not stressed as the work surface is elevated or lowered.

### BRIEF DESCRIPTION OF THE DRAWINGS

The above-mentioned and other features and advantages of this invention, and the manner of attaining them, will become more apparent and the invention will be better understood by reference to the following description of an embodiment of the invention taken in conjunction with the accompanying drawings, wherein:

FIG. 1 is a side view of an embodiment of an electrical receptacle assembly of the present invention mounted to a vertically adjustable work surface;

FIG. 2 is a perspective view of the electrical receptacle assembly of FIG. 1; and

FIG. 3 is a side view of the electrical receptacle assembly of FIGS. 1 and 2.

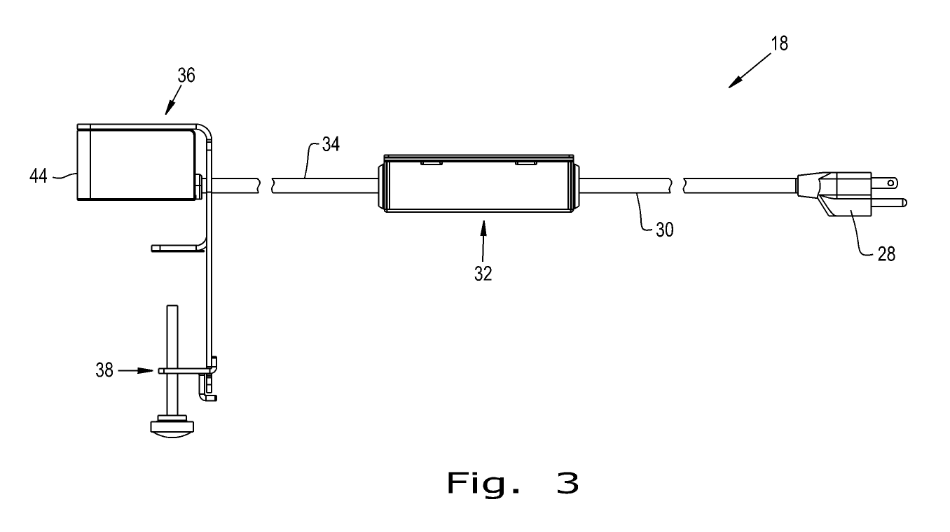

Corresponding reference characters indicate corresponding parts throughout the several views. The exemplifications set out herein illustrate embodiments of the invention, and such exemplifications are not to be construed as limiting the scope of the invention in any manner.

### DETAILED DESCRIPTION OF THE INVENTION

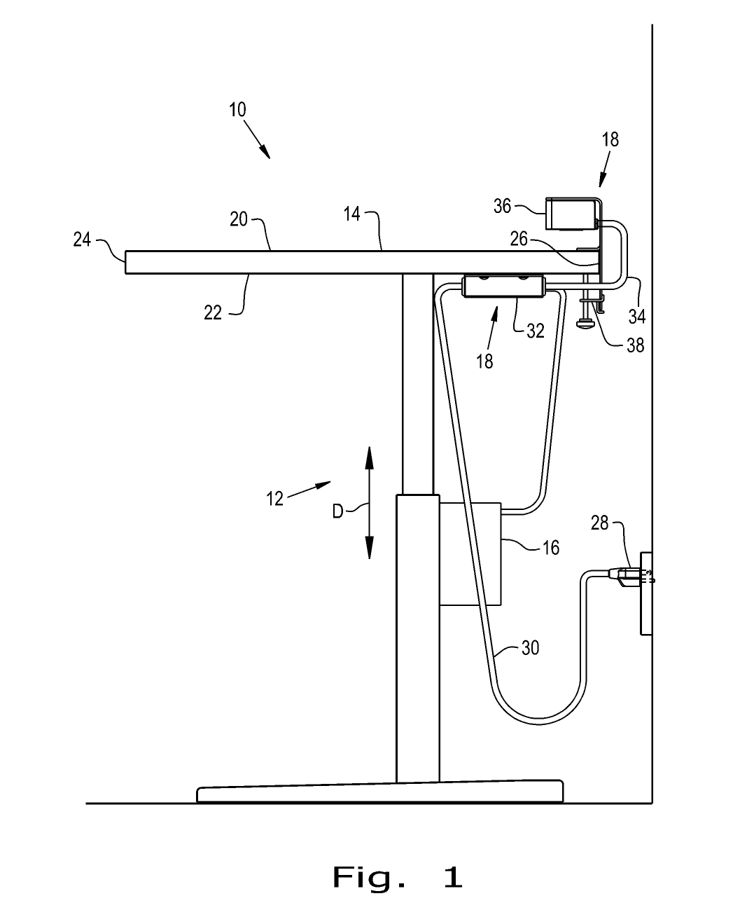

Referring now to FIG. 1, there is shown an embodiment of an elevatable work apparatus 10 including an elevatable workstation 12, a work surface 14, an elevation changing mechanism 16, and an electrical receptacle assembly 18 coupled to work surface 14. Work surface 14 has a topside surface 20, a bottom side 22, a front edge 24 and a back edge 26. Sides 20 and 22 are generally horizontal and edges 24 and 26 are generally vertical.

Elevation changing mechanism 16 is coupled to a portion of workstation 12 and moves work surface 14 in a generally up and down direction D by way of a control, not shown.

Electrical receptacle assembly 18 is an in-line power unit 18 and includes an electrical plug 28, a power cable 30, a housing 32, a power cable 34 and a housing 36. Housing 36 has a clamping mechanism 38 that engages bottom 22 to hold housing 36 in an elevated position above side 20. Clamping mechanism 38 runs along edge 26 and is generally aligned with edge 26 along edge 26. Clamping mechanism 38 is a securing technique 38, and it is contemplated that securing technique 38 can be in the form of fasteners that would engage work surface 14 to hold housing 36 thereto. Securing technique 38 can also be in the form of the insertion of housing 36 into a pocket, hole or cavity in work surface 14 thereby presenting housing 36 as built into work surface 14.

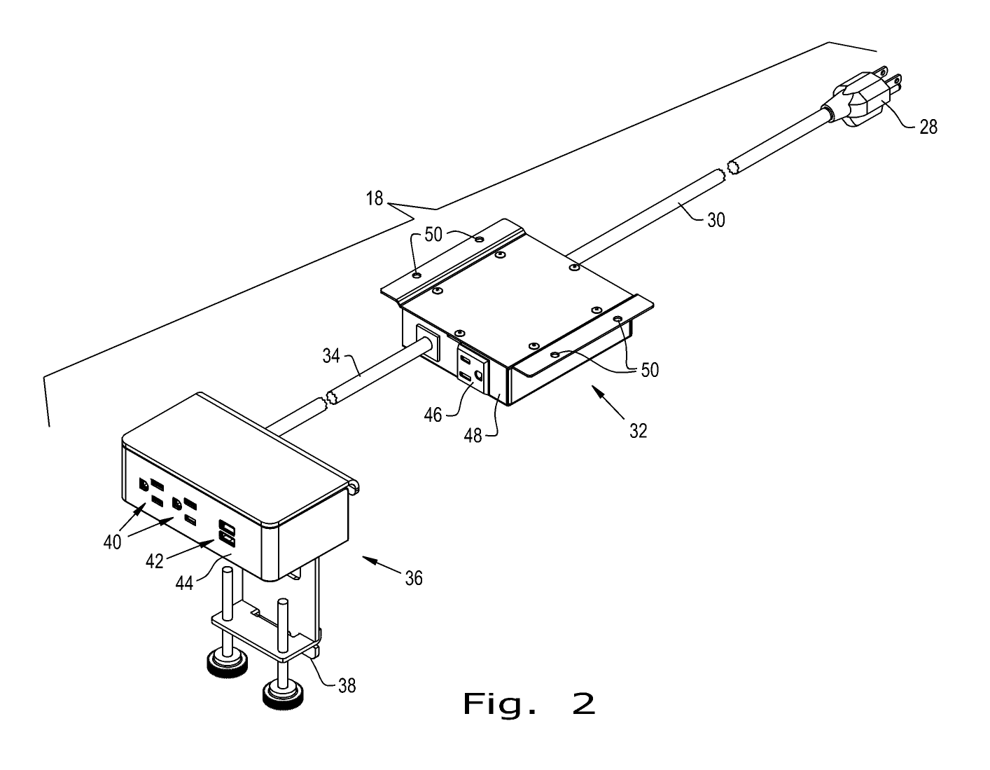

Now, additionally referring to FIG. 2, there is shown a perspective view of electrical receptacle assembly 18. Housing 36 has electrical receptacles 40 and data and/or power receptacles 42 positioned on a face 44. Housing 32 has an electrical power receptacle 46 positioned on a face 48 thereof. Housing 32 also has holes 50 through which fasteners are situated to couple housing 32 to side 22 of surface 14.

Elevatable work apparatus 12 has electrical receptacle assembly 18 coupled thereto and the elevation changing mechanism 16 is coupled to the work surface 14 so as to raise and lower surface 14 as directed by a user. Electrical receptacle assembly 18 is situation such that electrical power cable 30 provides electrical power to housing 32, and electrical power cable 34 is directly electrically coupled to electrical power cable 30 inside of housing 32. Elevation changing mechanism is electrically coupled to housing 32 or to another electrical outlet. Housing 36 has electrical receptacle connectors 40 presented on face 44 thereof. Electrical power cable 34 is coupled to housing 36 and supplies electrical power to electrical receptacles 40.

Housing 32 is coupled to bottom side 22 of work surface 14. Housing 36 is coupled to top side 20 of work surface 14, and is secured to work surface 14 by way of clamping mechanism 38. Electrical power cable 34 is less than half of as long as electrical power cable 30, and may be less than one fourth as long as electrical power cable 30.

Advantageously electrical receptacle assembly 18 is coupled to surface 14, with one portion 36 on top and the other portion 32 beneath. This allows for there to be no or at least reduced stress on power cable 34 as surface 14 is moved in direction D. Further, the present invention eliminates the daisy chaining of power strips, which can present electrical concerns in the workplace. The direct electrical coupling of power cables 30 and 34 and the presenting of electrical outlet 46 meets the electrical needs beneath surface 14 while precluding the daisy chaining of multiple power strips.

While electrical receptacles have been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

1. An elevatable work apparatus with an electrical receptacle assembly, the apparatus comprising:
a work surface; and
an elevation changing mechanism coupled to the work surface, the electrical receptacle assembly being coupled to the work surface, the electrical receptacle assembly including:
a first electrical power cable having at least one electrical conductor;
a second electrical power cable having at least one electrical conductor;
a first housing having at least one electrical power receptacle, the first electrical power cable by way of the at least one electrical conductor within the first electrical power cable providing electrical power to the first housing, the at least one electrical conductor of the second electrical power cable being directly electrically coupled to that at least one electrical conductor of the first electrical power cable within the first housing; and
a second housing having at least one electrical receptacle connector presented on a face thereof, the second electrical power cable being coupled to the second housing, the at least one electrical conductor of the second electrical power cable supplying electrical power to the at least one electrical receptacle of the second housing, the second housing being directly coupled to the work surface.

2. The apparatus of claim 1, wherein the first housing is coupled to a bottom side of the work surface.

3. The apparatus of claim 2, wherein the second housing is coupled to a top side of the work surface.

4. The apparatus of claim 3, wherein the second housing is secured to the work surface by way of one of a clamping mechanism, fasteners and insertion into a cavity in the work surface.

5. The apparatus of claim 3, wherein a back side of the second housing is generally aligned with a generally vertical portion of the work surface.

6. The apparatus of claim 3, wherein the second housing includes a portion that extends to the bottom of the work surface.

7. The apparatus of claim 1, wherein the second electrical power cable is less than half of as long as the first electrical power cable.

8. The apparatus of claim 1, wherein the elevation changing mechanism is electrically coupled to the receptacle of the first housing.

9. An electrical receptacle assembly for attachment to a work surface, the assembly comprising:
a first electrical power cable having at least one electrical conductor;
a second electrical power cable having at least one electrical conductor;
a first housing having at least one electrical power receptacle, the first electrical power cable by way of the at least one electrical conductor within the first electrical power cable providing electrical power to the first housing, the at least one electrical conductor of the second electrical power cable being directly electrically coupled to that at least one electrical conductor of the first electrical power cable within the first housing; and
a second housing having at least one electrical receptacle connector presented on a face thereof, the second electrical power cable being coupled to the second housing, the at least one electrical conductor of the second electrical power cable supplying electrical power to the at least one electrical receptacle of the second housing, the second housing being configured to be directly coupled to the work surface.

10. The electrical receptacle assembly of claim 9, wherein the first housing is coupled to a bottom side of the work surface.

11. The electrical receptacle assembly of claim 10, wherein the second housing is coupled to a top side of the work surface.

12. The electrical receptacle assembly of claim 11, wherein the second housing is secured to the work surface by way of a clamping mechanism.

13. The electrical receptacle assembly of claim 11, wherein a back side of the second housing is generally aligned with a generally vertical portion of the work surface.

14. The electrical receptacle assembly of claim 11, wherein the second housing includes a portion that extends to the bottom of the work surface.

15. The electrical receptacle assembly of claim 9, wherein the second electrical power cable is less than half of the length than the first electrical power cable.
